(19) United States
(12) Patent Application Publication
(10) Pub. No.: US 2009/0232312 A1
(43) Pub. Date: Sep. 17, 2009

(54) ENCRYPTED CONTENT REPRODUCTION DEVICE, ENCRYPTED CONTENT REPRODUCTION METHOD, PROGRAM, AND RECORDING MEDIUM FOR STORING THE PROGRAM

(75) Inventors: Yukiko Inoue, Osaka (JP); Hirokazu So, Osaka (JP); Masato Suto, Osaka (JP); Takuji Maeda, Osaka (JP); Makoto Ochi, Osaka (JP); Shinji Inoue, Osaka (JP); Kazuya Fujimura, Nara (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/719,792

(22) PCT Filed: Nov. 22, 2005
(86) PCT No.: PCT/JP05/21454

§ 371 Date: May 21, 2007

(30) Foreign Application Priority Data
Nov. 24, 2004 (JP) 2004-338428

(51) Int. Cl. H04L 9/08; G06F 21/24; G11B 20/10

(52) U.S. Cl. 380/278

(57) ABSTRACT

The invention presents an encrypted content playback equipment capable of decryption and playback of an encrypted content by using key information when a key medium storing the key information is not inserted, an encrypted content playback method, a program, and a recording medium for storing the program.

An encrypted content playback equipment 100 obtains key information 1 for a key medium 120, and stores the key information 1 in a provisional-key storage memory 102 as provisional key 1a, and obtains provisional-key usage limitation information 2 for limiting the use of provisional key 1a from the key medium 120. The encrypted content playback equipment 100 judges whether the provisional key 1a is usable or not based on the provisional-key usage limitation information 2, and if usable, plays back an encrypted content 3 by using the provisional key 1a.

### TECHNICAL FIELD

The invention relates to an encrypted content playback equipment that decrypts an encrypted content, an encrypted content playback method, a program, and a recording medium for storing the program.

### BACKGROUND ART

Conventionally, when storing digital copyrighted goods in a recording medium such as a semiconductor memory, a magnetic disk, or a magneto-optical disk, the digital copyrighted goods are generally encrypted, so that copyrights of the digital copyrighted goods are protected. The encrypted digital copyrighted goods (hereinafter called “encrypted content”) are usually stored in an area (hereinafter called “user's area”) not requiring authentication of the recording medium.

Key information used for encrypting the digital copyrighted goods is often stored in the recording medium so that it may not be easily seen by the user. For example, it is proposed that an area (hereinafter called “protected area”) requiring mutual authentication is provided in the recording medium, and the key information is stored in the protected area, so that the encrypted content is protected (see patent document 1).

An encrypted content playback equipment for playing back the encrypted content obtains the key information and the encrypted content from the inserted recording medium, and decrypts the encrypted content by key information to play back the content.

It may be also considered to obtain the encrypted content from other recording medium than the recoding medium (hereinafter called “key medium”) which stores the key information, or from a server on network.

When obtaining the encrypted content from the key medium, or when obtaining the encrypted content from the network, key information is essential for decrypting the encrypted content and playing back the digital copyrighted goods.

Patent document 1: JP-A-2003-233795

### DISCLOSURE OF INVENTION

### Problems to be Solved by the Invention

The prior art, however, has the following problems. The conventional encrypted content playback equipment can use key information only while the key medium is inserted. Accordingly, if a plurality of key information and a plurality of encrypted contents are stored in one key medium, while one encrypted content playback equipment is playing back any of the encrypted contents, other encrypted content playback equipment cannot play back other encrypted content recorded in the same key medium. If the encrypted content stored in the user's area is copied in other encrypted content playback equipment, the specification does not allow the key information stored in the protected area to be copied, and a plurality of key information stored in one key medium cannot be used simultaneously.

In a network for home, when an encrypted content is stored in a server device, and when desired to enjoy the encrypted content by accessing one server device from a plurality of rooms, if there is only one key medium in which key information is recorded, the key medium must be physically moved to individual rooms. That is, the encrypted content in the server cannot be used simultaneously in a plurality of rooms. Or the key medium must be always inserted in the server device.

The invention is devised in view of the problems discussed above, and it is intended to present an encrypted content playback equipment capable of decrypting and playing back an encrypted content by key information without inserting key medium having the key information, an encrypted content playback method, a program, and a recording medium for storing the program.

### Means for Solving the Problems

The encrypted content playback equipment of the invention has an insertion section, in which a key medium that stores key information for decrypting an encrypted content is inserted, and which obtains the key information; a storage section that stores provisionally the key information obtained from the key medium as a provisional key; a provisional-key usage limitation processing section that controls permission of use of the provisional key; and a decryption section that decrypts the encrypted content by using the provisional key.

According to the invention, by copying the key information of the key medium to the storage section of an internal memory as provisional key, the encrypted content can be decrypted and played back by using the provisional key without inserting the key medium. Besides, since the use of the provisional key is limited by the provisional-key usage limitation processing section, the copyright of the encrypted content can be protected.

The provisional-key usage limitation processing section may control permission of use of the provisional key based on a condition specified by provisional-key usage limitation information.

The provisional-key usage limitation processing section may have a register that stores temporarily the provisional-key usage limitation information. The provisional-key usage limitation information may be stored in the storage section.

When the provisional-key usage limitation information is stored in the key medium together with the key information, the provisional-key usage limitation processing section may obtain the provisional-key usage limitation information from the key medium.

When the provisional-key usage limitation processing section judges based on provisional-key usage limitation information that the provisional key cannot be used, the provisional-key usage limitation processing section may delete the provisional key from the storage section.

The provisional-key usage limitation information may contain a limit number for limiting the number of times of playback of the content. The provisional-key usage limitation information may contain the time limit for limiting playback time of the content. The provisional-key usage limitation information may contain a limit distance for limiting the distance capable of playing back the content.

When the encrypted content is stored in the key medium, the encrypted content playback equipment may obtain the encrypted content from the key medium.

When the encrypted content is stored in a server connected with the encrypted content playback equipment through a network, the encrypted content playback equipment may obtain the encrypted content from the server.

In case where the key medium stores the encrypted key information in a user's area being read or written regardless of result of mutual authentication, and stores a decrypting key for decrypting the encrypted key information in a protected area being read or written only when mutual authentication is successful, when the key medium is inserted in the insertion section, the storage section stores the encrypted key information as a provisional key and also stores the decrypting key, and the decryption section first decrypts the encrypted provisional key by using the decrypting key, and then decrypts the encrypted content by using the decrypted provisional key.

If the provisional-key usage limitation information is contained in the encrypted content, the provisional-key usage limitation processing section may obtain the provisional-key usage limitation information from the encrypted content being decrypted by the decryption section, and may continue decrypting of the encrypted content when the provisional key is judged to be usable, or may stop decrypting of the encrypted content when the provisional key is judged to be not usable, based on provisional-key usage limitation information.

An encrypted content playback method of the invention provides the steps of: obtaining the key information from a key medium having key information for decrypting an encrypted content and storing the key information as a provisional key; controlling permission for use of the provisional key; and decrypting the encrypted content by using the provisional key.

According to the invention, by copying the key information of key medium as the provisional key, the encrypted content can be decrypted and played back by using the provisional key even when the key medium is not inserted. Since the use of the provisional key is limited, the copyright of the encrypted content can be protected.

At the step of controlling permission for use of the provisional key, the permission for use of the provisional key may be controlled based on the condition specified by the provisional-key usage limitation information. The provisional-key usage limitation information may be stored in the key medium together with the key information.

The encrypted content playback method of the invention may further have a step of deleting the provisional key when it is judged based on the provisional-key usage limitation information that the provisional key cannot be used.

In the encrypted content playback method of the invention, the provisional-key usage limitation information may contain a limit number for limiting the number of times of playback of the content. The provisional-key usage limitation information may contain the time limit for limiting playback time of the content. The provisional-key usage limitation information may contain a limit distance for limiting a distance capable of playing back the content.

In case where the key information is encrypted and stored in a user's area being read or written regardless of result of mutual authentication by the key medium, and a decrypting key for decrypting the encrypted key information is stored in a protected area being read or written only when mutual authentication by the key medium is successful, at the step of storing the provisional key, the encrypted key information may be stored as a provisional key and the decrypting key may be stored, and at the step of decrypting the encrypted content, the encrypted provisional key may be first decrypted by using the decrypting key, and then the encrypted content may be decrypted by using the decrypted provisional key.

When the provisional-key usage limitation information is contained in the encrypted content, at the step of controlling permission for use of provisional key, the provisional-key usage limitation information may be obtained from within the encrypted content being decrypted at the step of decrypting the encrypted content, and decrypting of encrypted content may be continued when the provisional key is judged to be usable, or decrypting of the encrypted content may be stopped when the provisional key is judged to be not usable, based on the provisional-key usage limitation information.

At least part of the encrypted content playback method of the invention may be realized as a program capable to be executed by a computer resource. Such program may be recorded in a recording medium capable to be read by a computer.

### EFFECTS OF THE INVENTION

According to the encrypted content playback equipment, the encrypted content playback method, the program and the recording medium of the invention, the encrypted content can be decrypted by the key information and played back even when the key medium is not inserted.

### BRIEF DESCRIPTION OF DRAWINGS

FIG. 1 is a block diagram showing configurations of an encrypted content playback equipment and a key medium in an embodiment 1 of the invention.

FIG. 2 is a flowchart showing a method of obtaining key information from the key medium in encrypted content playback equipment in the embodiment 1 of the invention.

FIG. 3 is a flowchart of outline of the encrypted content playback method in the embodiment 1 to an embodiment 6 of the invention.

FIG. 4 is a flowchart showing a method of playing back the encrypted content by using a provisional key in the embodiment 1 of the invention.

FIG. 5 is a block diagram showing configurations of an encrypted content playback equipment and a key medium in an embodiment 2 of the invention.

FIG. 6 is a flowchart showing a method of obtaining the encrypted content from the key medium in the encrypted content playback equipment in the embodiment 2 of the invention.

FIG. 7 is a flowchart showing a method of playing back encrypted content by a provisional key in the embodiment 2 of the invention.

FIG. 8 is a diagram of outline of obtaining key information by a plurality of encrypted content playback equipments in the embodiment 2 of the invention.

FIG. 9 is a block diagram showing configurations of an encrypted content playback equipment and a key medium in an embodiment 3 of the invention.

FIG. 10 is a flowchart showing a method of playing back the encrypted content by using a provisional key in the embodiment 3 of the invention.

FIG. 11 is a diagram of example of provisional-key usage limitation information of the invention.

FIG. 12 is an outline diagram for obtaining the encrypted content from a server in a plurality of encrypted content playback equipment in an embodiment 4 of the invention.

FIG. 13 is a flowchart showing an encrypted content playback method in the embodiment 4 of the invention.

FIG. 14 is a block diagram of configurations of an encrypted content playback equipment and a key medium in an embodiment 5 of the invention.

FIG. 15 is a flowchart of method of obtaining a decrypting key from the key medium in the encrypted content playback equipment in the embodiment 5 of the invention.

FIG. 16 is a block diagram of configurations of an encrypted content playback equipment and a key medium in an embodiment 6 of the invention.

FIG. 17 is a flowchart showing a method of an playing back encrypted content by using a provisional key in embodiment 6 of the invention.

### DESCRIPTION OF THE REFERENCE NUMERALS

1, 1b Key information
1a, 1ab Provisional key
2, 2b, 2c Provisional-key usage limitation information
3, 3c Encrypted content
100, 500, 900, 1500, 1700 Encrypted content playback equipment
101 Provisional-key usage limitation processing section
102 Provisional-key storage memory
103 Decryption processing section
104 Key medium insertion section
105 Playback processing section
106 Register
120, 520, 920, 1520, 1720 Key medium
121 Data storage section
122 Protected area
123 User's area
124 Host interface
506 Encrypted content storage memory
507 Time measuring section
907 Distance measuring section
925 Position transmitter
1260 Server

### BEST MODE FOR CARRYING OUT THE INVENTION

Embodiments for carrying out the invention are described below with reference to the accompanying drawings.

### Embodiment 1

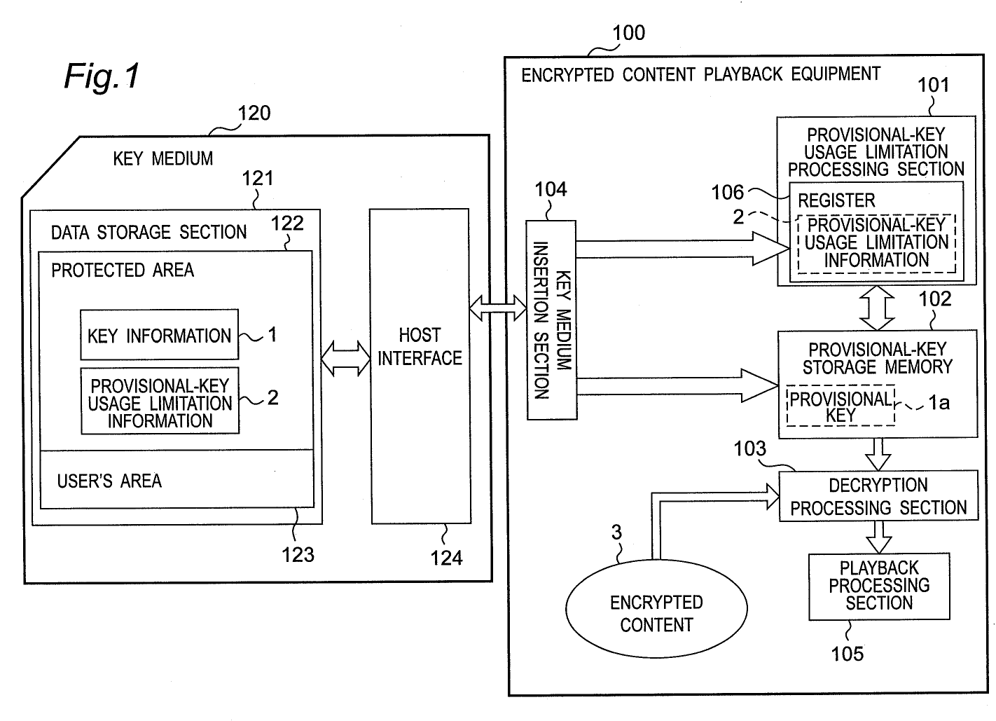

With reference to FIG. 1 to FIG. 4, an encrypted content playback equipment and an encrypted content playback method in an embodiment 1 of the invention will be described. FIG. 1 shows principal configurations of the encrypted content playback equipment and a key medium in the embodiment. An encrypted content playback equipment 100 is, for example, a secure digital (SD) audio player, and a key medium 120 is, for example, an SD memory card (the same applies to other embodiments).

The key medium 120 is a recording medium in which key information is recorded, and includes a data storage section 121 such as a flash memory having a recording area, and a host interface 124 for exchanging data with the encrypted content playback equipment 100 being a host device. The data storage section 121 includes a protected area 122 allowed to read and write only when successful in mutual authentication with the host device, and a user's area 123 allowed to read and write without the mutual authentication.

The protected area 122 stores key information 1 for decrypting an encrypted content 3, that is, an encrypted digital copyrighted goods, and provisional-key usage limitation information 2 for limiting the use of a provisional key 1a. The provisional key 1a is key information temporarily stored in the encrypted content playback equipment 100, and is obtained by copying the key information 1.

The encrypted content playback equipment 100 has a key medium insertion section 104 into which the key medium 120 is inserted, a provisional-key storage memory 102, that is, a storage section, for storing the key information 1 obtained from the key medium 120 as provisional key 1a, and a provisional-key usage limitation processing section 101 that limits the use of the provisional key 1a according to a the provisional-key usage limitation information 2 obtained from the key medium 120. The provisional-key usage limitation processing section 101 has a register 106, and stores the provisional-key usage limitation information 2 obtained from the key medium 120 in the register 106.

The register 106 is means for temporarily storing data necessary for processing as required. For example, after storing the provisional-key usage limitation information 2 concerning certain key information in the register 106, when the encrypted content playback equipment 100 executes other process than decrypting of an encrypted content 3 relating to the key information, the data used in other process is written in the register 106, and the stored provisional-key usage limitation information 2 is erased from the register 106. By contrast, the provisional-key storage memory 102 continues to store the once stored provisional key 1a until erased by the provisional-key usage limitation processing section 101, and the provisional key 1a is not erased if the encrypted content playback equipment 100 executes other process than decrypting of the encrypted content 3.

The encrypted content playback equipment 100 further includes a decryption processing section 103 that decrypts the encrypted content 3 by using key information 1 of the key medium 120 or the provisional key 1a stored in the provisional-key storage memory 102, and a playback processing section 105 that plays back the decrypted content. In the embodiment, the encrypted content 3 is preliminarily set in the encrypted content playback equipment 100. For example, a medium, such as CD, storing the encrypted content 3 is, for example, inserted in the encrypted content playback equipment 100.

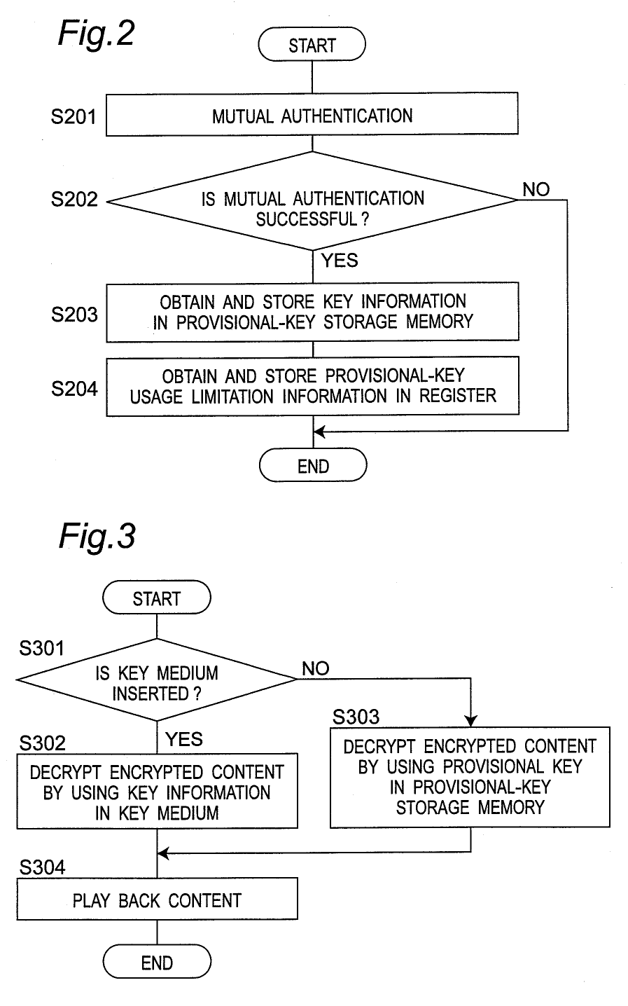

FIG. 2 shows a method of obtaining the key information 1 and the provisional-key usage limitation information 2 from the key medium 120 by the encrypted content playback equipment 100. When the key medium 120 is inserted in the key medium insertion section 104 of the encrypted content playback equipment 100, the encrypted content playback equipment 100 performs mutual authentication with the key medium 120 (S201). When mutual authentication is successful (S202), the encrypted content playback equipment 100 obtains the key information 1 from the protected area 122 by way of the host interface 124, and stores the key information 1 as provisional key 1a in the provisional-key storage memory 102 (S203).

Next, the encrypted content playback equipment 100 obtains the provisional-key usage limitation information 2 from the protected area 122 by way of the host interface 124, and stores the provisional-key usage limitation information 2 in the register 106 (S204).

In the embodiment, when the key medium 120 is inserted in the encrypted content playback equipment 100, processing shown in FIG. 2 is executed automatically. However, after inserting the key medium 120, by manipulating the switch or the like provided in the encrypted content playback equipment 100, the key information 1 and provisional-key usage limitation information 2 may be obtained.

In the embodiment, the encrypted content playback equipment 100 first stores the key information 1 (S203), and then stores the provisional-key usage limitation information 2 (S204), but the same effect is obtained if the provisional-key usage limitation information 2 is first stored and then the key information 1 is stored.

FIG. 3 shows an outline of encrypted content playback method. When playing back the encrypted content 3, first, the encrypted content playback equipment 100 judges whether the key medium 120 is inserted or not in the key medium insertion section 104 (S301). If the key medium 120 is inserted, the decryption processing section 103 decrypts the encrypted content 3 by using the key information 1 of the key medium 120 (S302). If the key medium 120 is not inserted, the decryption processing section 103 decrypts the encrypted content 3 by using the provisional key 1a stored in the provisional-key storage memory 102 (S303). The playback processing section 105 plays back the decrypted content (S304). If the key medium 120 is inserted, the encrypted content 3 may be decrypted by using the provisional key 1a.

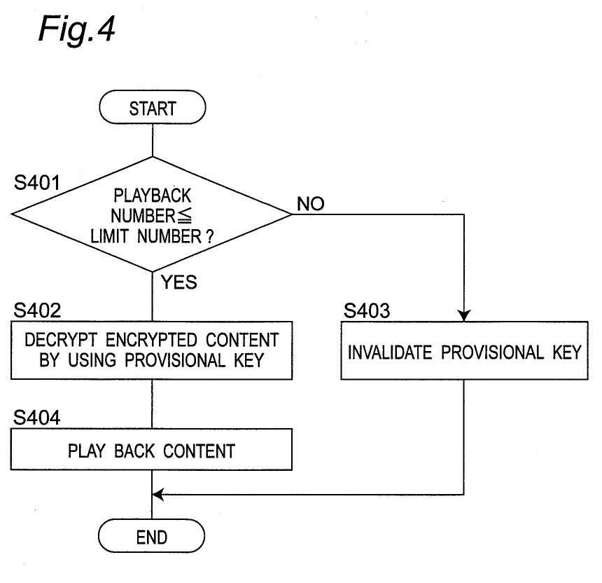

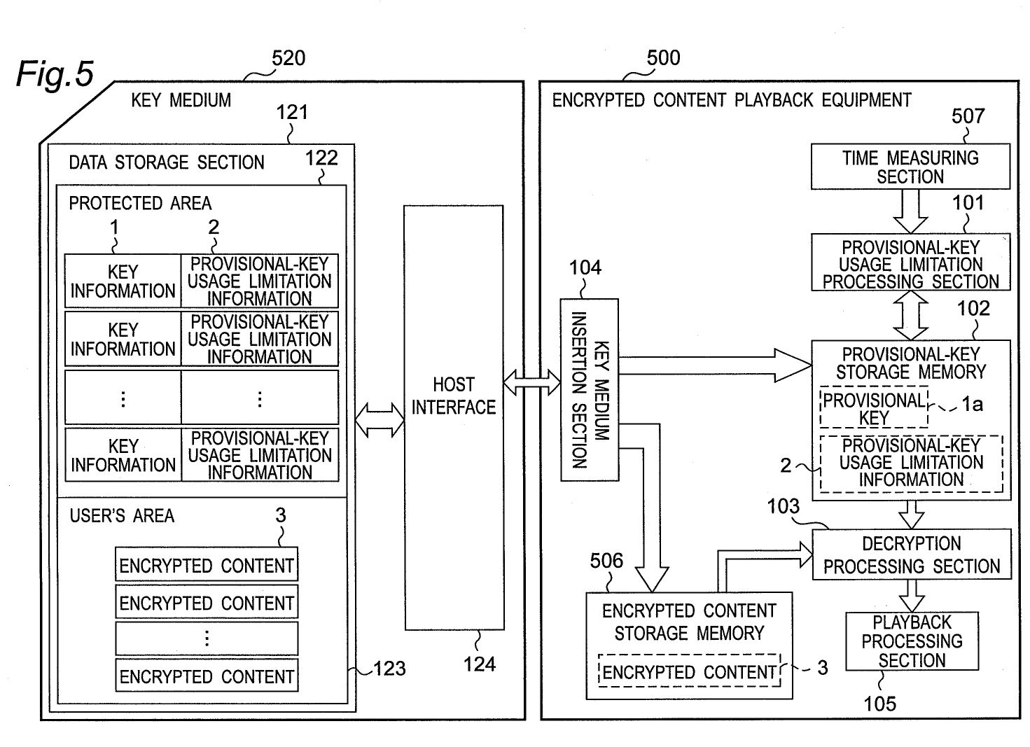

FIG. 4 specifically shows a method of decrypting and playing back the encrypted content by using the provisional key at step 303 and step 304 in FIG. 3. In the embodiment, the provisional-key usage limitation information 2 is number limit information showing the number of times for limiting the number of playback of a content. The provisional-key usage limitation processing section 101 has a number control function for monitoring the number of playback of the encrypted content 3, and counts the number of playback when the content is actually played back while the key medium 120 is not inserted in the key medium insertion section 104.

In FIG. 4, the provisional-key usage limitation processing section 101 judges whether or not to use the provisional key 1a based on the provisional-key usage limitation information 2. Specifically, the provisional-key usage limitation processing section 101 judges whether or not the number of actual playback is not over the number of limit indicated by the provisional-key usage limitation information 2 (S401).

If the playback number exceeds the limit number at step 401, the provisional-key usage limitation processing section 101 judges that the provisional key 1a is not usable, and the provisional key 1a of provisional-key storage memory 102 is invalidated (S403). With respect to invalidate, for example, if the provisional key 1a has a flag showing validity or invalidity, invalidity may be set in the flag, or the provisional key 1a may be deleted from the provisional-key storage memory 102.

If the playback number is not over the limit number, the provisional-key usage limitation processing section 101 judges that the provisional key is usable. Hence, the provisional-key usage limitation processing section 101 processes nothing particular about the provisional key 1a.

The decryption processing section 103 decrypts the encrypted content 3 by using the provisional key 1a stored in the provisional-key storage memory 102 (S402). The playback processing section 105 plays back the content (S404). The provisional-key usage limitation processing section 101 counts up the number of times of actual playback of content.

According to the embodiment, for example, if the limit number of provisional-key usage limitation information 2 is once, after the key medium 2 is drawn out from the encrypted content playback equipment 100, the encrypted content can be decrypted and played back only once by using the obtained provisional key 1a. But after playing back once, the provisional key 1a is invalidated and cannot be used, and the content cannot be played back second time and after.

Thus, according to the embodiment, without inserting the key medium 120, the encrypted content playback equipment 100 can play back the encrypted content 3 by using the provisional key 1a.

Also according to the embodiment, since the use of provisional key 1a is limited to a finite number of times by using the provisional-key usage limitation information 2, limitless use of provisional key 1a is prevented. Further, by invalidating the provisional key 1a according to the provisional-key usage limitation information 2, the copyright of the content can be protected.

When the encrypted content playback equipment 100 executes other process than playback, the provisional-key usage limitation information 2 stored in the register 106 is erased. That is, when the provisional-key usage limitation information 2 is stored in the register 106 as in the embodiment, the provisional key 1a can be used only right after the key medium 120 is drawn out, and limitless use of provisional key 1a is prevented.

The key information 1 stored in the protected area 122 of the key medium 120 may be or may not be encrypted. When the key information 1 of the key medium 120 is encrypted, the encrypted content playback equipment 100 may store the encrypted key information 1 directly as provisional key 1a, or if the key information 1 is not leaded outside, it may be decrypted and stored.

As in the embodiment, when both key information 1 and provisional-key usage limitation information 2 are stored in the protected area 122 of the key medium 120, correspondence between key information 1 and provisional-key usage limitation information 2 can be achieved easily. However, as far as the correspondence between key information 1 and provisional-key usage limitation information 2 is established, the provisional-key usage limitation information 2 may be obtained aside from the key information 1. For example, the provisional-key usage limitation information 2 may be obtained by using a network or other medium connected by wire or without wire to the encrypted content playback equipment 100.

In FIG. 1, the key information 1 and encrypted content 3 are shown by one piece each, but the combination of the key information 1 and the encrypted content 3 may be either one set or plural sets. In the embodiment, the key information 1 and provisional-key usage limitation information 2 are in pairs, but when the encrypted content 3 and key information 1 are in pairs, the key information 1 and provisional-key usage limitation information 2 may not be in pairs. For example, one provisional-key usage limitation information 2 may limit the use of a plurality of key information 1. Or the key information 1 may be common to a plurality of encrypted contents 3, and, use of common key information 1 may be limited by one or more provisional-key usage limitation information 2.

### Embodiment 2

With reference to FIG. 5 to FIG. 8, an encrypted content playback equipment and an encrypted content playback method according to an embodiment 2 of the invention are described. FIG. 5 shows principal configurations of an encrypted content playback equipment and a key medium in the embodiment.

The encrypted content playback equipment 500 of the embodiment 2 differs from the encrypted content playback equipment 100 of the embodiment 1 only in that a time measuring section 507 and an encrypted content storage memory 506 are provided. The time measuring section 507 measures the time from the moment that a key medium 520 is drawn out from the key medium insertion section 104, and outputs the measured time. The encrypted content storage memory 506 stores the encrypted content 3.

What the key medium 520 of the embodiment 2 differs from the key medium 120 of the embodiment 1 lies in that a plurality of encrypted contents 3 are stored in the user's area 123 of the key medium 520, and that the same number of key information 1 and provisional-key usage limitation information 2 as the number of encrypted contents 3 are stored in the protected area 122. In the embodiment, the provisional-key usage limitation information 2 is the time limit information showing the time limit indicating the upper limit of time capable of playing back the contents. Other configuration of the embodiment 2 is the same as that in the embodiment 1.

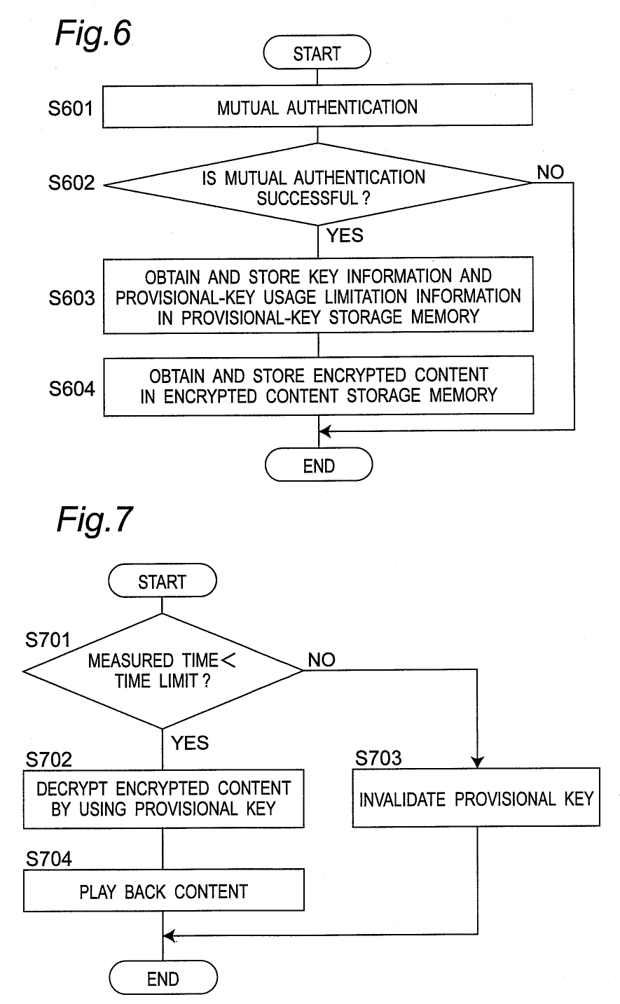

FIG. 6 shows a method of obtaining key information 1, provisional-key usage limitation information 2, and an encrypted content 3 from the key medium 520 by encrypted content playback equipment 500 of the embodiment. When the key medium 520 is inserted in the key medium insertion section 104 of the encrypted content playback equipment 500, the encrypted content playback equipment 500 performs mutual authentication with the key medium 520 (S601). When the mutual authentication is successful (S602), the encrypted content playback equipment 500 obtains the key information 1 and the provisional-key usage limitation information 2 from the protected area 122 by way of the host interface 124, and stores them in the provisional-key storage memory 102 (S603).

Next, the encrypted content playback equipment 500 obtains the encrypted content 3 from the user's area 123 by way of the host interface 124, and stores it in the encrypted content storage memory 506.

Referring to FIG. 7, the content playback method by the encrypted content playback equipment 500 is explained. The provisional-key usage limitation processing section 101 judges whether or not to use the provisional key 1a based on the provisional-key usage limitation information 2. Specifically, the provisional-key usage limitation processing section 101 judges whether or not the time measured by the time measuring section 507 is less than the time limit of provisional-key usage limitation information 2 (S701).

If the measured time is less than the time limit, the provisional-key usage limitation processing section 101 judges that the provisional key 1a is usable. The decryption processing section 103 decrypts the encrypted content 3 by using the provisional key 1a stored in the provisional-key storage memory 102 (S702). The playback processing section 105 plays back the content (S704).

At step S701, if the measured time is not less than the time limit, the provisional-key usage limitation processing section 101 judges that the provisional key is not usable, and invalidates the provisional key in the provisional-key storage memory 102 (S703).

The time measuring section 507 is always outputting the measured time. That is, the provisional-key usage limitation processing section 101 returns to step 701 during playback of the content at step 704, and compares the measured time with the time limit always or at specified time intervals. When the measured time exceeds the time limit, step 703 is executed, and playback of the content is stopped.

According to the embodiment, for example, when the time limit of provisional-key usage limitation information 2 is 1 hour, within 1 hour after the key medium 520 is drawn out, the encrypted content playback equipment 500 can decrypt and play back the encrypted content 3 by using the provisional key. When exceeding 1 hour after removal of key medium 520, the provisional key is invalidated, and the encrypted content 3 cannot be played back.

In the embodiment, the data of provisional-key usage limitation information 2 can be set for each encrypted content. That is, the time limit can be changed for each encrypted content.

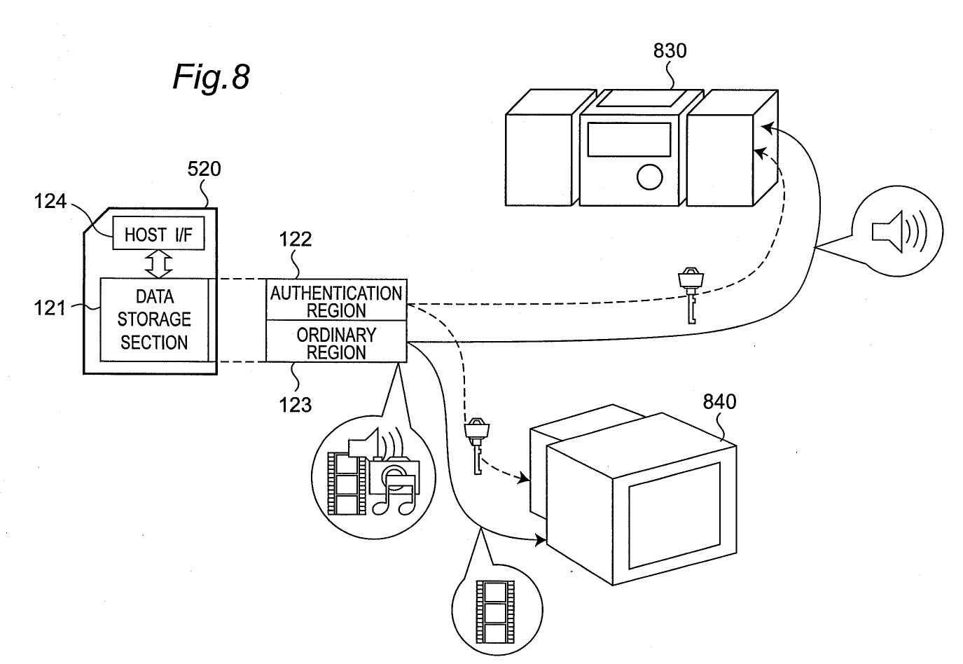

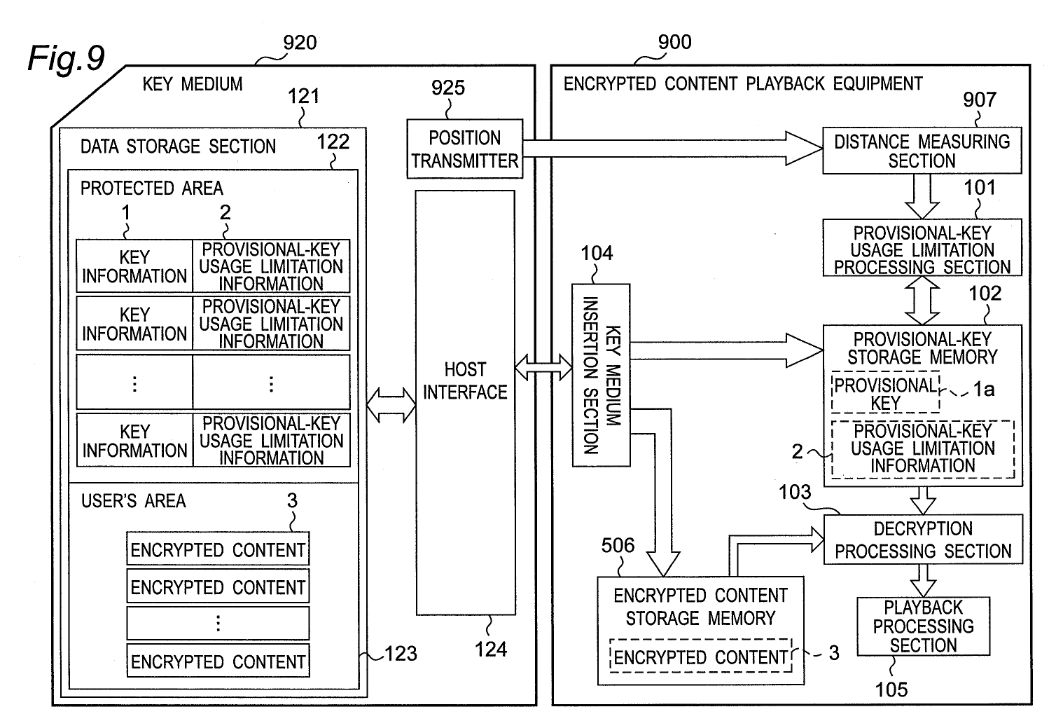

FIG. 8 is a diagram of state of obtaining key information 1, provisional-key usage limitation information 2, and the encrypted content 3 from the same key medium 520 by an audio player 830 and a television 840. The audio player 830 and the television 840 have the configuration of the encrypted content playback equipment 500 shown in FIG. 5, and obtain the key information 1, provisional-key usage limitation information 2 and the encrypted content 3 from the key media 520 individually according to the flowchart of FIG. 6. Then, without inserting key medium 520, the audio player 830 and television 840 can play back the encrypted content 3 simultaneously according to the flowchart of FIG. 7.

Thus, according to the embodiment, whether the key medium 520 is inserted or not, the encrypted content playback equipment 500 can play back the encrypted content 3 by using the provisional key 1a, so that the encrypted content 3 can be played back simultaneously by different equipments.

According to the embodiment, since the use of provisional key is limited in finite time by using the provisional-key usage limitation information 2, limitless use of provisional key is prevented. Further, by invalidating the provisional key according to the provisional-key usage limitation information 2, the copyright of the content can be protected.

In the embodiment, since the encrypted content 3 and key information 1 are stored in the same medium, the encrypted content 3 can be played back if only one medium 520 is available. Correspondence of encrypted content 3 and key information 1 can be established easily.

In addition, in FIG. 6, the encrypted content 3 may be obtained (S604) prior to obtaining of key information 1 and provisional-key usage limitation information 2 (S603).

In the embodiment, the time measuring section 507 starts measuring the time after the key medium 520 is drawn out, and outputs the measured time. But the measured time is not limited to this example. The time measuring section 507 may start measuring the time when playback of the content is started and output the total time up to the present time, or output the total of actual playback time as the measured time. The provisional-key usage limitation processing section 101 may compare the measured time with the time limit of provisional-key usage limitation information 2, and may judge whether the provisional key is usable or not.

If a plurality of encrypted contents 3 are stored in the key medium 520, the encrypted content playback equipment 500 may obtain all encrypted contents 3 and all key information 1 and provisional-key usage limitation information 2, or may also obtain selected encrypted contents 3 only, and corresponding key information 1 and provisional-key usage limitation information 2 only.

If a plurality of encrypted contents 3 are stored in the encrypted content storage memory 506, the encrypted content playback equipment 500 may process all encrypted contents 3 as specified in FIG. 7, decrypt and play back the encrypted contents 3 sequentially. Or only the selected encrypted contents 3 may be played back according to FIG. 7.

### Embodiment 3

With reference to FIG. 9 to FIG. 11, an encrypted content playback equipment and an encrypted content playback method in an embodiment 3 of the invention are described. FIG. 9 shows principal configurations of an encrypted content playback equipment and a key medium in the embodiment.

What the embodiment 3 differs from the embodiment 2 lies in the configuration in which a key medium 920 has a position transmitter 925 for transmitting position information of the key medium, and an encrypted content playback equipment 900 has a distance measuring section 907 that receives the position information of the key medium, measures the distance of the encrypted content playback equipment 900 and the key medium 920, and outputs the measured distance. The position transmitter 925 is, for example, a global positioning system, and outputs degrees of latitude and longitude of the key medium 920. In the embodiment, the provisional-key usage limitation information 2 is the distance limit information showing the limit distance as upper limit of distance allowing the provisional key 1a to be used. Other configuration of the embodiment 3 is the same as that of the embodiment 2.

The encrypted content playback equipment 900 of the embodiment obtains the key information 1, the provisional-key usage limitation information 2, and the encrypted content 3 from the key medium 920 according the flowchart in FIG. 6.

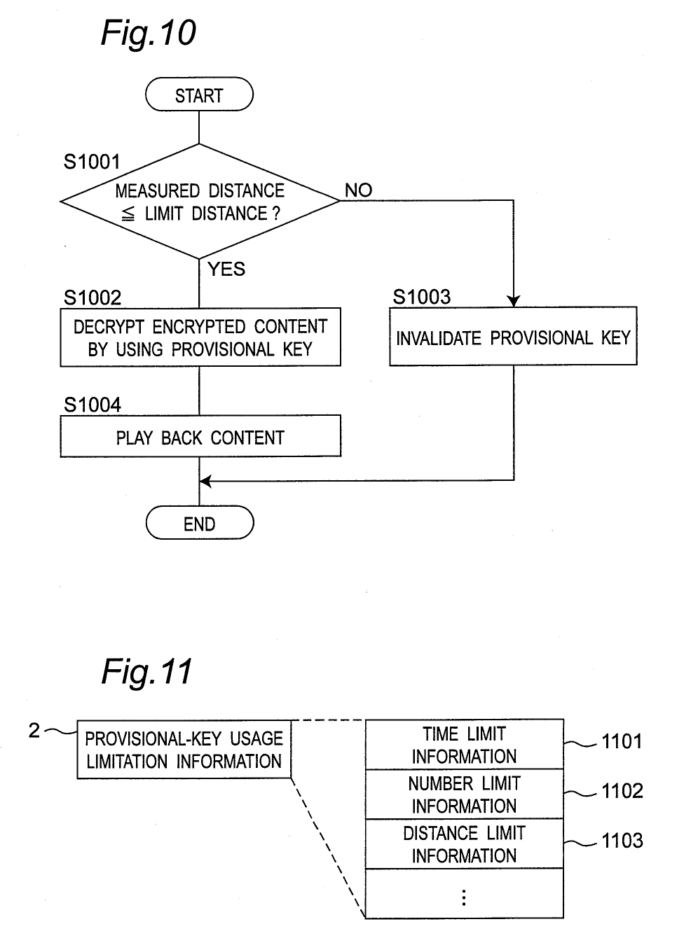

Playback method of the encrypted content when the key medium 920 is not inserted is explained by referring to FIG. 10. First, the provisional-key usage limitation processing section 101 judges whether the provisional key is usable or not based on the provisional-key usage limitation information 2. Specifically, the provisional-key usage limitation processing section 101 judges whether the distance between the key medium 920 and the encrypted content playback equipment 900 measured by the distance measuring section 907 is not over the limit distance shown by the provisional-key usage limitation information 2 (S1001).

If the measured distance is not over the limit distance, the provisional-key usage limitation processing section 101 judges that the provisional key is usable. The decryption processing section 103 decrypts the encrypted content 3 by using the provisional key 1a stored in the provisional-key storage memory 102 (S1002). The playback processing section 105 plays back the content (S1004).

If the measured distance is over the limit distance, the provisional-key usage limitation processing section 101 judges that the provisional key is not usable, and the provisional key in the provisional-key storage memory 102 is invalidated (S1003).

The distance measuring section 907 is measuring the distance of key medium 920 and the encrypted content playback equipment 900 always or at specified time intervals. That is, the provisional-key usage limitation processing section 101 returns to step 1001 during content playback at step 1004, and compares the measured distance and the limit distance, and when the measured distance exceeds the limit distance, the step 1003 is executed, and playback of the content is stopped at the same time.

Thus, according to the embodiment, without inserting key medium 920, the encrypted content playback equipment 900 can play back the encrypted content 3 by using the provisional key 1a. For example, the same encrypted content can be enjoyed among family members and friends staying within a limit distance range simultaneously by using plural equipments.

In the embodiment, since the use of provisional key 1a is limited in a finite distance by using provisional-key usage limitation information 2, limitless use of provisional key 1a is prevented. For example, after enjoying the encrypted content, when the equipments are gotten away from one another, the encrypted content cannot be used in the equipment in which the memory card being the key medium is not inserted. Further, by invalidating the provisional key 1a according to the provisional-key usage limitation information 2, the copyright of the content can be protected.

Instead of the position transmitter 925 and the distance measuring section 907 of the embodiment, the key medium 920 and the encrypted content playback equipment 900 have a wireless communication section, such as infrared or Bluetooth means, which performs wireless communication, respectively. For example, the provisional-key usage limitation information 2 includes information for limiting the use of the provisional key depending on the distance between the key medium 920 and the encrypted content playback equipment 900. In this case, the provisional-key usage limitation processing section 101 permits use of the provisional key only when communication is established by the wireless communication section, and invalidates the use of the provisional key when the communication is interrupted. The provisional-key usage limitation information 2 may include the information showing the lower limit of intensity of radio wave applicable to wireless communication, and the provisional-key usage limitation processing section 101 may permit use of the provisional key only when the communication wave is stronger than the intensity shown by the provisional-key usage limitation information 2, and may invalidate use of the provisional key when the communication wave is weaker than the intensity shown by the provisional-key usage limitation information 2.

In the embodiment 1 through the embodiment 3, the provisional-key usage limitation information 2 respectively includes the limit number, the time limit, and the limit distance, but these conditions may be combined in plural sets as shown in FIG. 11. For example, if the condition includes time limit information 1101 permitting use of the provisional key 1a for three hours after start of content playback, number limit information 1102 permitting playback of the content for three times by the provisional key 1a, and distance limit information 1103 permitting use of provisional key 1a only when the key medium is present within a distance of 50 meters, the provisional-key usage limitation processing section 101 judges as follows. The provisional-key usage limitation processing section 101 judges that the provisional key 1a is usable for 3 hours after start of the encrypted content, but invalidates the provisional key 1a when the distance of key medium 920 and the encrypted content playback equipment 900 is longer than 50 meters, so that the encrypted content cannot be played back. Even if the time after start of playback is within three hours and the key medium exists within 50 meters, after the same content is viewed three times, the provisional-key usage limitation processing section 101 invalidates the provisional key 1a on the moment, so that the encrypted content 3 cannot be played back again.

In the embodiment 1 through the embodiment 3, the provisional-key usage limitation information 2 includes the number limit information for showing the number of times of limit, time limit information for showing the time limit, or distance limit information for showing the limit distance, but these conditions are not particularly specified as far as the use of the key can be limited.

### Embodiment 4

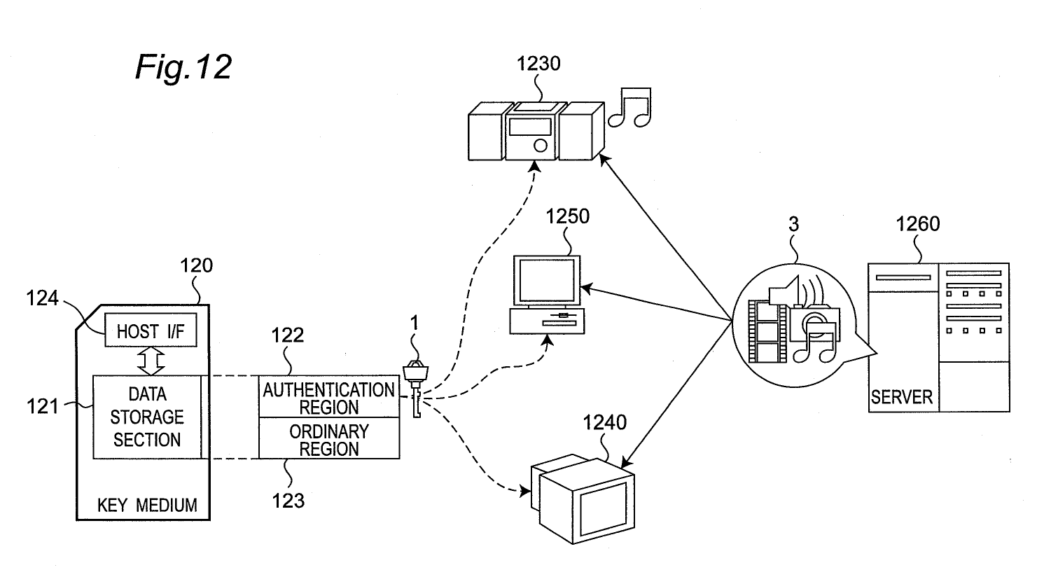

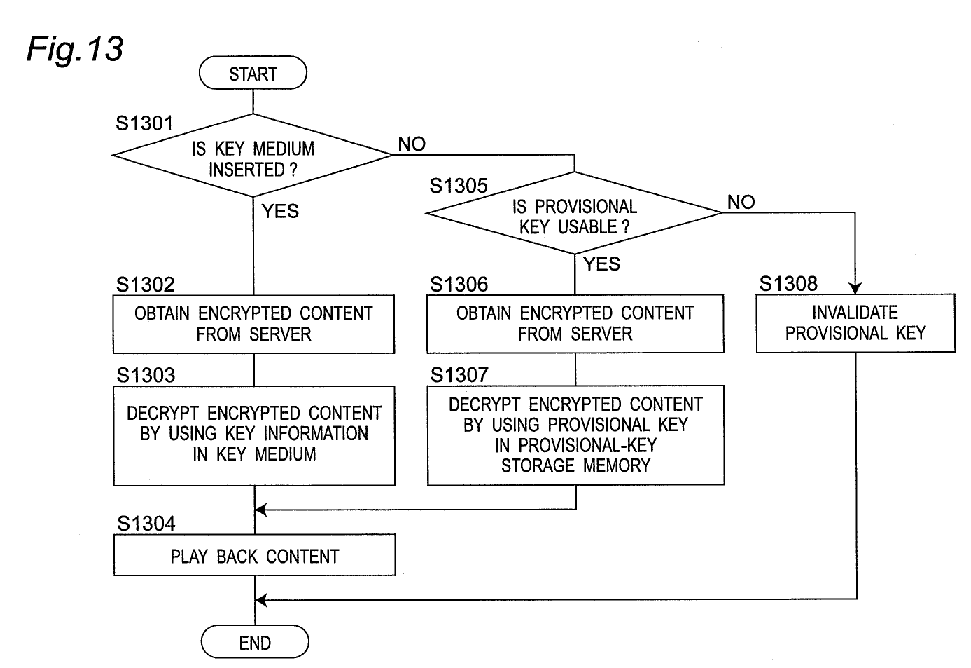

With reference to FIG. 12 and FIG. 13, an encrypted content playback equipment and an encrypted content playback method according to an embodiment 4 of the invention are described. In the embodiment, the encrypted contents 3 are stored in an integrated fashion in a server 1260, and the encrypted content playback equipment obtains the encrypted contents 3 from the server 1260, and plays back the encrypted contents 3.

In FIG. 12, an audio player 1230, a television 1240, and a personal computer 1250 include the configuration of encrypted content playback equipment according to the embodiment 1. FIG. 12 shows an outline configuration in which the audio player 1230, the television 1240, and the personal computer 1250 obtains encrypted content 3 from the server 1260 and obtains key information 1 from key medium 120. In the embodiment, the audio player 1230, the television 1240, and the personal computer 1250 are connected to the server 1260 by wired or wireless network.

The key medium 120 is inserted into the audio player 1230, the television 1240, and the personal computer 1250 of the embodiment, respectively, and they obtain the key information 1 and provisional-key usage limitation information 2 from the key medium 120 according to the flowchart in FIG. 2.

The method of playing back the encrypted content by audio player 1230 is explained by referring to FIG. 13. The audio player 1230 judges whether the key medium 120 is inserted or not (S1301). When the key medium 120 is inserted in the audio player 1230, the audio player 1230 obtains the encrypted content 3 from the server 1260 (S1302). The decryption processing section 103 of the audio player 1230 decrypts the encrypted content 3 by the key information 1 of the key medium 120 (S1303), and plays back the content (S1304).

If the key medium 120 is not inserted, the provisional-key usage limitation processing section 101 judges whether the provisional key in the provisional-key storage memory 102 is usable or not (S1305). If the provisional key is usable, the audio player 1230 obtains the encrypted content 3 from the server 1260 (S1306). The decryption processing section 103 decrypts the encrypted content 3 by the provisional key (S1307), and the playback processing section 105 plays back the decrypted content (S1304). If the key medium 120 is inserted, it may be also judged if the provisional key is usable or not.

The provisional-key usage limitation processing section 101 invalidates the provisional key if the provisional key is judged to be not usable (S1308).

As in the case of the audio player 1230, the television 1240 and the personal computer 1250 obtain the encrypted content 3 from the server 1260 and play back it according to the flowchart in FIG. 13.

According to the embodiment, in each one of the audio player 1230, the television 1240, and the personal computer 1250, when key information 1 is preliminarily obtained from one key medium 120. If the key medium 120 is not inserted at the time of playback, the encrypted content 3 can be obtained from the common server 1260, and played back simultaneously.

The audio player 1230, the television 1240, and the personal computer 1250 shown in FIG. 12 include the configuration of encrypted content playback equipment in the embodiment 1, but may also include the configuration of encrypted content playback equipment in the embodiment 2 or the embodiment 3. In this case, the encrypted content 3 received from the server 1260 can be stored in the encrypted content storage memory 506. Accordingly, the timing for obtaining the encrypted content 3 from the server 1260 is not limited to the step 1302 or the step 1306, but may be anytime before decrypting of the encrypted content 3. For example, before the key information 1 is obtained from the key medium 120, the encrypted content 3 may be received from the server 1260.

In addition, the encrypted content playback equipment is not limited to the audio player, the television or the personal computer. Any other equipment may be used as far as having the constituent elements in the encrypted content playback equipment in the embodiment 1 to the embodiment 3.

### Embodiment 5

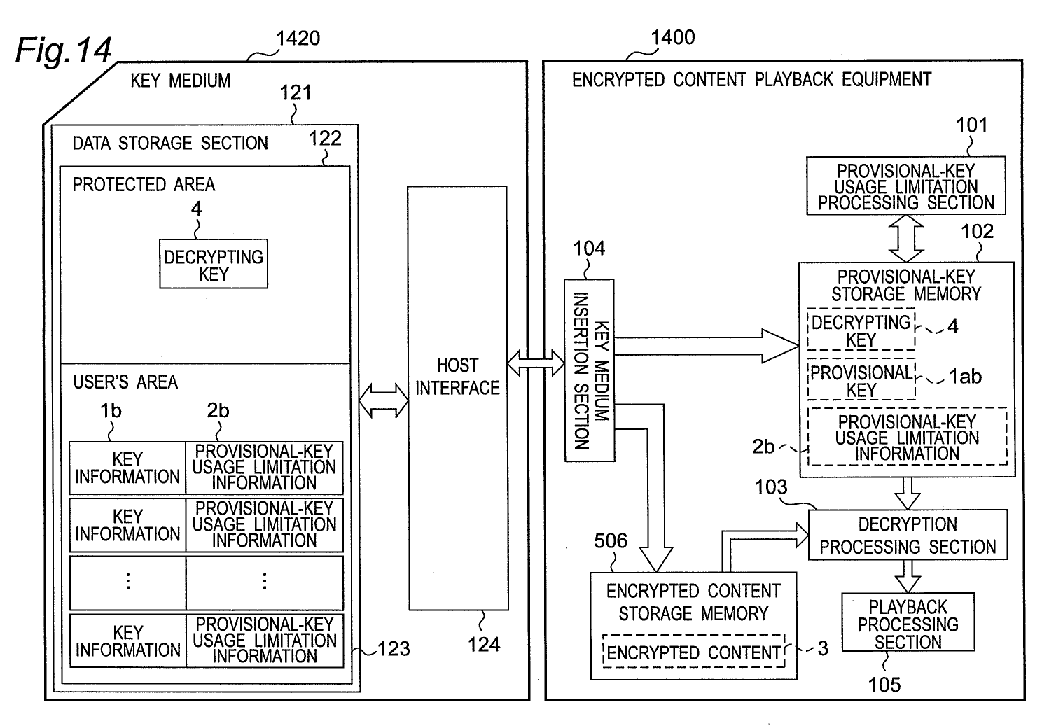

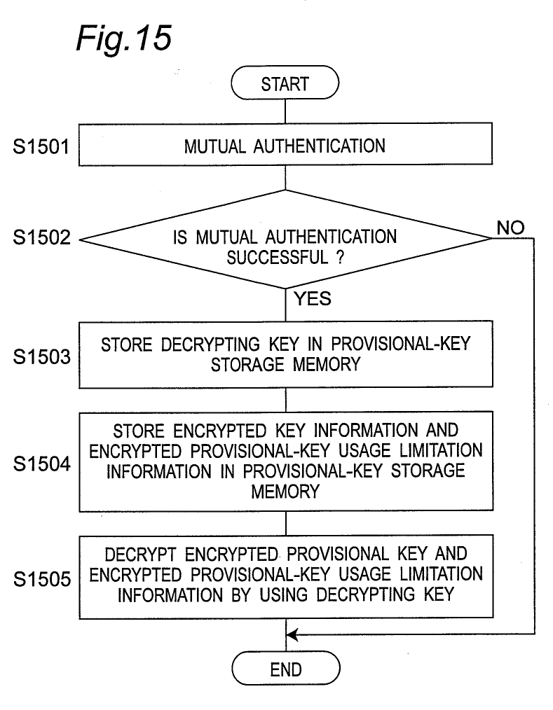

With reference to FIG. 14 and FIG. 15, an encrypted content playback equipment and an encrypted content playback method in an embodiment 5 of the invention are described. Different from the embodiment 1 to the embodiment 4, in a key medium 1420 in embodiment 5 shown in FIG. 14, key information 1b and provisional-key usage limitation information 2b are encrypted and stored in user's area 123. In protected area 122, a decrypting key 4, which is a key for decrypting the encrypted key information 1b and provisional-key usage limitation information 2b, is stored.

With reference to FIG. 15, a method of obtaining decrypting key 4 and others from the key medium 1420 by the encrypted content playback equipment 1400 in the embodiment 5, will be described. The encrypted content playback equipment 1400 performs mutual authentication with the key medium 1420 (S1501) when the key medium 1420 is inserted in the key medium insertion section 104. When successful in mutual authentication (S1502), the decrypting key 4 stored in the protected area 122 is read out, and is stored in the provisional-key storage memory 102 (S1503).

Next, the key information 1b and provisional-key usage limitation information 2b stored in the user's area 123 are read out in encrypted state, and stored in provisional-key storage memory 102 (S1504). The key information 1b stored in provisional-key storage memory 102 is called provisional key lab.

Using the decrypting key 4, the decryption processing section 103 decrypts the provisional key lab and the provisional-key usage limitation information 2b (S1505).

Step 1505 is not particularly specified in sequence as far as it is before decrypting of the encrypted content 3. For example, step 1505 may be executed after the key medium 1520 is removed from the key medium insertion section 104 after step 1504. The decrypted provisional key lab and decrypted provisional-key usage limitation information 2b may be stored in the provisional-key storage memory 102 instead of the provisional key lab and of provision-key usage limitation information 2b before decrypting.

The encrypted content 3 and the key information 1b are in a relation of a pairs, and when the encrypted content 3 increases, the key information 1b also increases. On the other hand, the protected area 122 of the SD memory card being the key medium 1420 is generally smaller in capacity as compared with the user's area 123, and much key information cannot be stored. According to the embodiment, however, since more key information can be stored in the key medium 1420 by making use of the user's area, more encrypted contents 3 can be played back by the provisional key lab.

In the embodiment, the decrypting key 4 is stored in the protected area 122 of the key medium 1420 in which key information 1b and provisional-key usage limitation information 2b are stored, but the decrypting key 4 is not needed in the key medium 1420 not having the protected area 122. For example, encrypted key information 1b and encrypted provisional-key usage limitation information 2b may be stored in the key medium 1 not having protected area 122, and the decrypting key 4 may be stored in other medium having the protected area. Nothing is particularly specified as far as the key information 1b and provisional-key usage limitation information 2b can be decrypted by the encrypted content playback equipment 1400.

### Embodiment 6

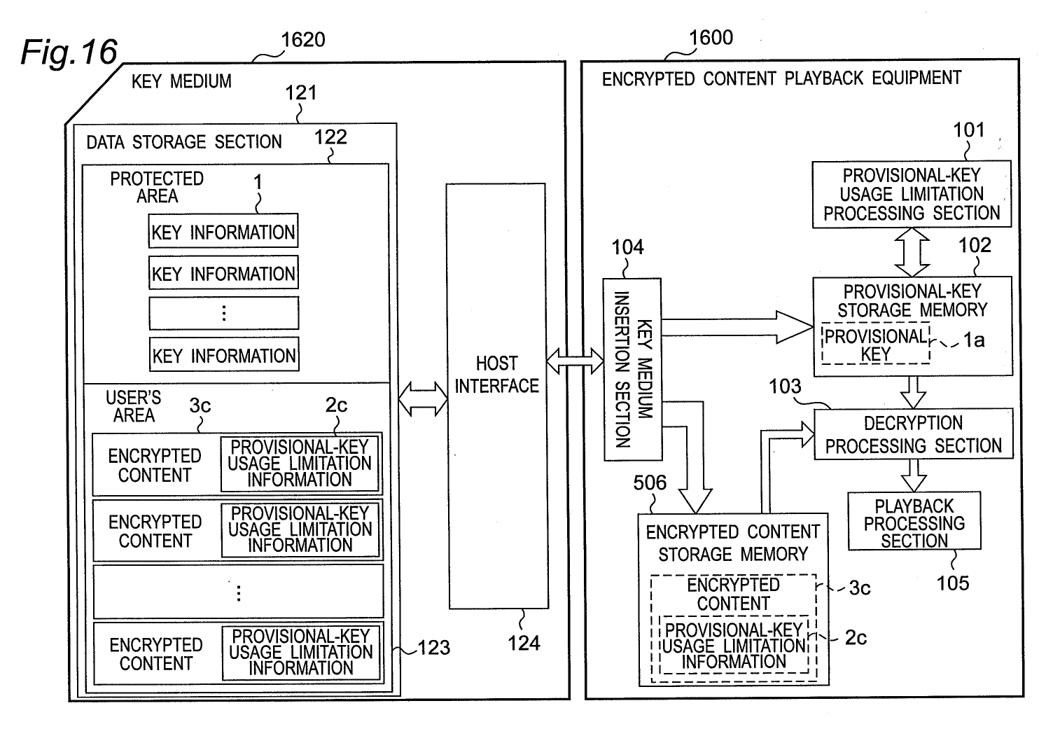

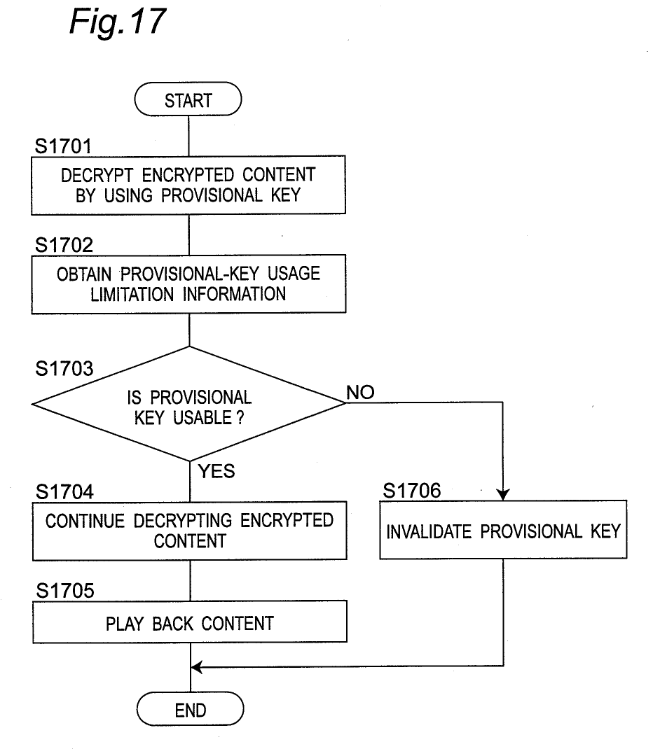

With reference to FIG. 16 and FIG. 17, an encrypted content playback equipment and an encrypted content playback method in an embodiment 6 of the invention are described. In the embodiment, provisional-key usage limitation information 2c is contained in an encrypted content 3c. The encrypted content 3c is stored in the user's area 123 of the key medium 1620, and key information 1 is stored in the protected area 122. The encrypted content playback equipment 1600 in the embodiment reads out the key information 1 from the protected area 122, and stores it in the provisional-key storage memory 102 as provisional key 1a, and reads out the encrypted content 3c from the user's area 123, and stores it in the encrypted content storage memory 3.

Method of playing back the encrypted content 3c obtained as described above is explained by referring to FIG. 17. FIG. 17 shows a method of playing back the encrypted content 3c when the key medium 1620 is not inserted in the key medium insertion section 104. First, the decryption processing section 103 starts decrypting the encrypted content 3c by using the provisional key 1a stored in the provisional-key storage memory 102 (S1701).

The provisional-key usage limitation processing section 101 obtains the provisional-key usage limitation information 2c from the decrypted portion of the encrypted content 3c (S1702). The provisional-key usage limitation processing section 101 judges whether the provisional key is continuously usable or not based on the provisional-key usage limitation information 2c (S1703). For example, if the provisional-key usage limitation information 2c contains a limit distance for limiting the distance between the key medium 1720 and the encrypted content playback equipment 1600, same as in embodiment 4, use of provisional key is judged based on the distance between the key medium 1620 and the encrypted content playback equipment 1600.

When the provisional-key usage limitation processing section 101 judges that the provisional key is usable, the decryption processing section 103 continues to decrypt the encrypted content 3c (S1704). The playback processing section 105 plays back the decrypted content (S1705).

When the provisional-key usage limitation processing section 101 judges that the provisional key is not usable, the provisional-key usage limitation processing section 101 invalidates the provisional key (S1706).

In addition, the encrypted content 3c containing the provisional-key usage limitation information 2c may be separately obtained from a server connected through a network, instead of obtaining from the key medium 1620 having key information 1.

In the embodiment, too, same as in embodiments 1 to 5, the same effects of playing back the encrypted content 3 without inserting the key medium 1620 are obtained.

The encrypted content playback method explained in the foregoing embodiments can be executed, at least in part, as a program that can be executed by a computer resource. Such program can be recorded in a recording medium that can be read by a computer.

### INDUSTRIAL APPLICABILITY

The invention is useful for an encrypted content playback equipment and an encrypted content playback method capable of playing back an encrypted content finitely without inserting a medium in which key information is recorded.

1. An encrypted content playback equipment comprising:
an insertion section, in which a key medium that stores key information for decrypting an encrypted content is inserted, and which obtains the key information;
a storage section that stores provisionally the key information obtained from the key medium as a provisional key;
a provisional-key usage limitation processing section that controls permission of use of the provisional key; and
a decryption section that decrypts the encrypted content by using the provisional key.

2. The encrypted content playback equipment according to claim 1, wherein the provisional-key usage limitation processing section controls permission of use of the provisional key based on a condition specified by provisional-key usage limitation information.

3. The encrypted content playback equipment according to claim 2, wherein the provisional-key usage limitation processing section has a register that stores temporarily the provisional-key usage limitation information.

4. The encrypted content playback equipment according to claim 2, wherein the provisional-key usage limitation information is stored in the storage section.

5. The encrypted content playback equipment according to claim 2, wherein the provisional-key usage limitation information is stored in the key medium together with the key information, and the provisional-key usage limitation processing section obtains the provisional-key usage limitation information from the key medium.

6. The encrypted content playback equipment according to claim 2, wherein when the provisional-key usage limitation processing section judges based on the provisional-key usage limitation information that the provisional key cannot be used, the provisional-key usage limitation processing section deletes the provisional key from the storage section.

7. The encrypted content playback equipment according to claim 2, wherein the provisional-key usage limitation information contains a limit number for limiting the number of times of playback of the content.

8. The encrypted content playback equipment according to claim 2, wherein the provisional-key usage limitation information contains a time limit for limiting playback time of the content.

9. The encrypted content playback equipment according to claim 2, wherein the provisional-key usage limitation information contains a limit distance for limiting a distance capable of playing back the content.

10. The encrypted content playback equipment according to claim 1, wherein the encrypted content is stored in the key medium, and the encrypted content is obtained from the key medium.

11. The encrypted content playback equipment according to claim 1, wherein the encrypted content is stored in a server connected with the encrypted content playback equipment through a network, and the encrypted content playback equipment obtains the encrypted content from the server.

12. The encrypted content playback equipment according to claim 1, wherein the key medium stores the encrypted key information in a user's area being read or written regardless of result of mutual authentication, and stores a decrypting key for decrypting the encrypted key information in a protected area being read or written only when mutual authentication is successful, when the key medium is inserted in the insertion section, the storage section stores the encrypted key information as a provisional key and also stores the decrypting key, and the decryption section first decrypts the encrypted provisional key by using the decrypting key, and then decrypts the encrypted content by using the decrypted provisional key.

13. The encrypted content playback equipment according to claim 2, wherein the provisional-key usage limitation information is contained in the encrypted content, the provisional-key usage limitation processing section obtains the provisional-key usage limitation information from the encrypted content being decrypted by the decryption section, and continues decrypting of the encrypted content when the provisional key is judged to be usable, or stops decrypting of the encrypted content when the provisional key is judged to be not usable, based on provisional-key usage limitation information.

14. An encrypted content playback method comprising the steps of:
obtaining key information from a key medium having the key information for decrypting an encrypted content and storing the key information as a provisional key;
controlling permission for use of the provisional key; and
decrypting the encrypted content by using the provisional key.

15. The encrypted content playback method according to claim 14, wherein at the controlling step, permission for use of the provisional key is controlled based on the condition specified by provisional-key usage limitation information.

16. The encrypted content playback method according to claim 15, wherein the provisional-key usage limitation information is stored in the key medium together with the key information.

17. The encrypted content playback according to claim 15, further comprising a step of deleting the provisional key when it is judged based on the provisional-key usage limitation information that the provisional key cannot be used.

18. The encrypted content playback method according to claim 15, wherein the provisional-key usage limitation information contains a limit number for limiting the number of times of playback of the encrypted content.

19. The encrypted content playback method according to claim 15, wherein the provisional-key usage limitation information contains a time limit for limiting playback time of the content.

20. The encrypted content playback method according to claim 15, wherein the provisional-key usage limitation information contains a limit distance for limiting a distance capable of playing back the content.

21. The encrypted content playback method according to claim 14, wherein the key information is encrypted and stored in a user's area being read or written regardless of result of mutual authentication by the key medium, and a decrypting key for decrypting the encrypted key information is stored in a protected area being read or written only when mutual authentication by the key medium is successful,
at the step of storing the provisional key, the encrypted key information is stored as a provisional key and the decrypting key is stored, and
at the step of decrypting the encrypted content, the encrypted provisional key is first decrypted by using the decrypting key, and then the encrypted content is decrypted by using the decrypted provisional key.

22. The encrypted content playback method according to claim 15, wherein the provisional-key usage limitation information is contained in the encrypted content, and
at the step of controlling permission for use of the provisional key, the provisional-key usage limitation information is obtained from within the encrypted content being decrypted at the step of decrypting the encrypted content, and
decrypting of the encrypted content is continued when the provisional key is judged to be usable, or decrypting of the encrypted content is stopped when the provisional key is judged to be not usable, based on the provisional-key usage limitation information.

23. A program for causing a computer to execute the steps of:
obtaining key information from a key medium having the key information for decrypting an encrypted content and storing the key information as a provisional key;
controlling permission for use of the provisional key; and
decrypting the encrypted content by using the provisional key.

24. The program according to claim 23, wherein at the controlling step, permission for use of the provisional key is controlled based on the condition specified by provisional-key usage limitation information.

25. The program according to claim 24, wherein the provisional-key usage limitation information is stored in the key medium together with the key information.

26. The program according to claim 24, further comprising a step of deleting the provisional key when it is judged based on provisional-key usage limitation information that the provisional key cannot be used.

27. The program according to claim 24, wherein the provisional-key usage limitation information contains a limit number for limiting the number of times of playback of the content.

28. The program according to claim 24, wherein the provisional-key usage limitation information contains a time limit for limiting playback time of the encrypted content.

29. The program according to claim 24, wherein the provisional-key usage limitation information contains a limit distance for limiting a distance capable of playing back the content.

30. The program according to claim 23, wherein the key information is encrypted and stored in a user's area being read or written regardless of result of mutual authentication by the key medium, and a decrypting key for decrypting the encrypted key information is stored in a protected area being read or written only when mutual authentication by the key medium is successful,
at the step of storing the provisional key, the encrypted key information is stored as a provisional key and the decrypting key is stored, and
at the step of decrypting the encrypted content, the encrypted provisional key is first decrypted by using the decrypting key, and then the encrypted content is decrypted by using the decrypted provisional key.

31. The program according to claim 24, wherein the provisional-key usage limitation information is contained in the encrypted content, and
at the step of controlling permission for use of the provisional key, the provisional-key usage limitation information is obtained from within the encrypted content being decrypted at the step of decrypting the encrypted content, and
decrypting of the encrypted content is continued when the provisional key is judged to be usable, or decrypting of the encrypted content is stopped when the provisional key is judged to be not usable, based on provisional-key usage limitation information.

32. A recording medium that stores a program of claim 23.
